(19) United States
(12) Patent Application Publication
(10) Pub. No.: US 2004/0239486 A1
(43) Pub. Date: Dec. 2, 2004

(54) Virtual cycling method and apparatus

(76) Inventors: Ming Li, Shenzhen (CN); Zhigang Rong, Shenzhen (CN); Jingyi Gao, Shenzhen (CN); Daoqiang Liu, Shenzhen (CN)

Correspondence Address: Shenzhen Hytechnology Inc., 23/F, Huaqiang Bldg A, 3006 Shennan Rd., Shenzhen, 518031, CN

(21) Appl. No.: 10/668,268

(22) Filed: Sep. 24, 2003

(30) Foreign Application Priority Data
May 27, 2003 (CN) 03126721.1

(51) Int. Cl. G08B 1/00

(52) U.S. Cl. 340/286.01

(57) ABSTRACT

A device or a method to realize virtual cycling: the method includes simulated motion, rotary wheel inspection, speed detecting and dynamic scene display; the said simulated motion include auto damp adjustment which is applied on resistance varying with the said scenes. The said equipment include bicycle, direction detector fixed on faucet devices for direction sense purpose, the speed detector fixed on pedal devices and damp force device, computer system and display system connected with the above three devices which is applied in data conducting, virtual scene and resistance adjusting signal output. The above two detectors are provided with sensors; the damp device has a generator with a convertible interior magnetic field. The virtual bicycle and cycling method as defined in the afore said invention bring full fun of striding over different scenes, as well as a kind of exercise effect.

### FIELD OF THE INVENTION

This invention is in the field of virtual reality technology on computer and sensor. More particularly, the invention relates to a virtual cycling method and apparatus.

### BACKGROUND OF THE INVENTION

Virtual reality technology as a virtual environment made up of hardware, software and various sensors, is a physical and functional thing or environment where users are engage on virtual interaction that they can or can't be realize.

This kind of virtual reality world is made possible through the computer and the relative equipment. The main hardware is composed of computer, monitor and interactive equipment that can simulate reality. The computer database preserves such information as image and sound of the simulated environment, and receives control signals produced by the interactive equipment.

Virtual reality technology has been applied in such fields as entertainment, medical, engineering and construction, education and training, military simulation, science and finance. Actually virtual racing facilities can be seen in most recreational sites. But the existing virtual racing car is from which an exercise effect is brought, but game machine. Though bicycle in health center are manpower driven, they are only for exercise use. You can experience no joy from the bald and non-interactive movement.

In view of the foregoing discussion, it would be desirable to provide a method and apparatus as virtual bicycle that is set up with resistance device which vary different scenes for both exercise and amusement purpose.

### SUMMARY OF THE INVENTION

The general purpose of the present invention is to solve such problems as how to use the computer, bicycle model, sensor and a certain mechanism to create a method or a device to realize virtual cycling in a limited space confronting with varying resistance that go with the changing scenes.

A method to realize virtual cycling: use the bicycle model, the sensor on the faucet, pedal-driven generator with adjustive interior magnetic field and computer system connecting with sensor and generator which is installed inside with virtual scene database; the method to simulate cycling motion by the said bicycle model and auto detecting method by the aforesaid direction sensor to simulate cycling in changing scene; the speed testing method by speed sensor, the obtained data obtained through the rotary test method and speed testing method of computer system and display system, and the dynamic display method of the said scene database; the motion simulating method comprise the damp auto adjusting method on the up-and-down resistance produced therewith when the computer system auto adjust the interior magnetic field of the generator with the changing scene. The method can be generalized as follows:

a. Using sensor to detect bicycle speed and direction;

b. Generating electricity through pedal by driving the generator with convertible interior magnetic field;

c. Displaying the scene according to the current location by computer installed with virtual scene database;

d. Changing the current location and corresponding scenes by the setup and detected speed and direction; and

e. Auto adjusting interior magnetic field of the said generator according to the changing scenes, to alter the cycling resistance produced hereby.

The method as provided in the invention: the scene database comprises different data corresponding to multiple cycling games, the scene database comprises resistance parameter corresponding to the said scenes, the resistance parameter may comprise cycle-way gradient of current scene. The scene varies with different games.

The method as provide in the invention: the damp auto adjusting method comprises the following:

a. Calculating the current speed of said simulated bicycle by the speed detecting method

b. Procuring the resistance parameter from the scene database: calculate the current resistance of the simulated bicycle by its speed and resistance parameter.

c. Adjusting the interior magnetic field of the generator and load capacity: Moment of resistance is at reverse ratio with resistance and increase with the accretion of interior magnetic field of generator; the formula is: T=κω/R, wherein ω is coefficient, k=(αΦ)²/η, wherein 101 is magnetic flux, a is coefficient, η is efficiency coefficient, ω is angular velocity of pedal, R is load resistance.

The technique is applied with the resistance that simulated the bicycle it confronts with.

The method as provided in the invention, the motion simulating method is as follows: magnify the cycling speed by adjusting the sprocket wheel and pulley devices in multilevel status to a certain extent which meet the required rotate speed when generator works at rated output.

In a preferred embodiment, the magnified speed is 39 times and the said multilevel is third level.

The said rotate testing method comprises gear wheel magnifying. In a preferred embodiment, the faucet rotate angle is set to ±25 and the said magnifying size is 6 times. This method is used to improve the test precision.

The said virtual scene is computerized 3D production with depth of fields. The display method adopts back projection or other display and projection devices.

The method as provided in the invention further comprising simulating the sound output of the changing background scene. The sensor may comprise direction sensor detecting the faucet and speed sensor.

Another technique can be solved through: constructing a virtual bicycle device comprising bicycle, direction detector fixed on faucet devices for direction sense purpose, the speed detector fixed on pedal devices and the damp force device, and computer system and display system connected with the above three devices which is applied in data processing, virtual scene output and resistance adjusting signal output. The damp device produces resistance by resistance adjusting signal and comprises a generator with a interior convertible magnetic field. The said direction detecting and speed testing devices have their own sensors.

In a preferred embodiment, the direction detector includes two gear wheels one is big and one small) on which the sensor linked with the small one. The big wheel connecting with the faucet bracket is positioned under the bracket. The said detecting device can be amplified by multilevel gear wheel.

The said pedaling device includes pedal, driver on axis, driven wheel on co-axis-of-rotation and secondary driver, secondary driven wheel on co-axis-of-rotation and third-rate driver, the third-grade driven and chain or pulley between driver and driven at different grade. In a preferred embodiment, the first-grade wheel is sprocket wheel, the secondary and the third-grade are pulley. The said sensor on speed detector can be fixed on each wheel of driver and driven wheel at different grade.

The damp device includes damp controller connected with computer system, excitation voltage adjustor, generator connected on the output terminal of adjustor, and load adjustor where loop and input terminal are connected with the said controller while the output terminal is connected with the changing load. The loop includes load forming electrical loop between generator and the output voltage test circuit connecting with computer system. The generator rotor is located on the axis of the said third-rate driven wheel. The load is convertible.

The computer system comprises input device used for startup device and game selection.

The input device comprises the intelligent card reading device used for startup and multi-functioned keystroke use for game selection. The keystroke can select different games. Each game has different scenes.

The said display system put right ahead of the faucet, connecting with the said computer system, can be back projection or other display equipment or projection equipment.

The implementation of the method or device for virtual cycling as provided in the invention can supply various simulated virtual scene and simulated cycling resistance. The multiple game options can provide riders with not only different experience or but also a kind of exercise effect.

### BRIEF DESCRIPTION OF THE DRAWINGS

FIG. 1 is an exterior structure sketch map of in a preferred embodiment of the invention.

FIG. 2 is an abridged general view of a preferred embodiment of the invention.

FIG. 3 is an interior structure side view of a preferred embodiment of the invention.

FIG. 4 is a hardware structural drawing of a preferred embodiment of the invention.

FIG. 5 is a logistic explosion view of a preferred embodiment of the invention.

FIG. 6 is a schematic diagram of control circuit on resistance adjustment as shown in FIG. 5 FIG. 7 is a schematic diagram of faucet direction device and direction testing device as shown in FIG. 5 FIG. 8 is an abridged general view of the software of a preferred embodiment of the invention.

### DETAILED DESCRIPTION OF THE PREFERRED EMBODIMENT

### Overview

The elements of the invention are as follows:

1. Speed testing: it is to test the rotate speed of pulley. Multiplied by speed parameter equals the motion speed. V=π×D×rps=π×D×n, wherein D is the diameter of virtual bicycle wheel, n is the parameter pulse value.

2. Calculation on resistance: calculate resistance by reading the resistance parameter value corresponding with the scene and the parameter value of the virtual cycle. Moment of resistance: T=kω/R, wherein k=(αφ)₂/η, k is coefficient, φ is magnetic flux, α is coefficient., η is efficiency coefficient, ω is pedal angle velocity, R is load resistance. The moment of resistance of the pedal is on reverse ratio of load resistance and on direct ratio of rotate speed. T=CφIₐ, wherein C is coefficient, φ is flux, Iₐ is excitation current. The moment of resistance increases with excitation current.

3. Automatically producing resistance: generate power by driving generator through pedal. The resistance varies by altering the excitation current and load resistance.

4. Direction detecting: the sensor is driven by faucet and gear wheel at a definite sensing proportion. In a preferred embodiment, the sensor is plastic potentiometer.

5. Simulated scene: comprising simulated display, sound and resistance parameter corresponding to each split scene. Back projection, other display or projection device can be used to display.

The invented device can be installed at gym or other amusement sites. The members or visitors may show an IC card (exercise type or amusement type) before playing. The exterior structure as shown on the drawings comprises bicycle model, crust and display screen; bicycle model comprises faucet, the multi-functional keystroke, IC card reader, pedal and saddle.

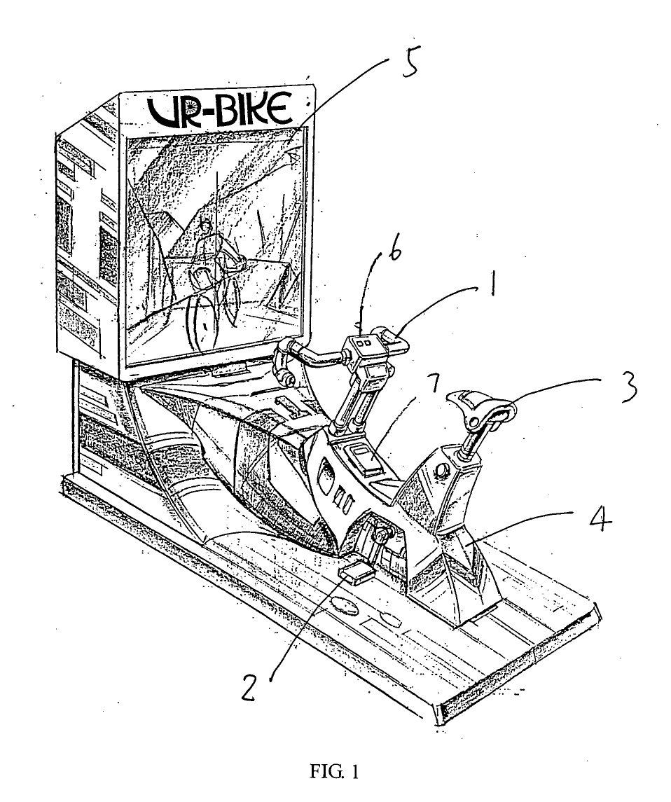

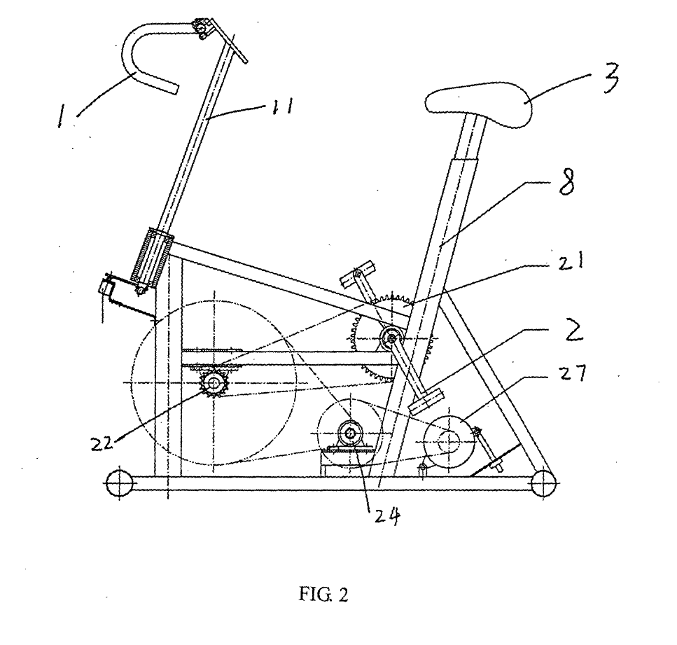

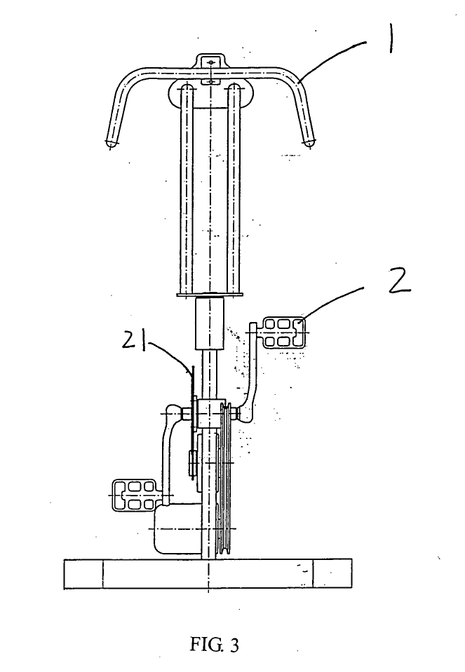

Referring now to the drawings, FIG. 1, FIG. 2 and FIG. 3 indicate that the apparatus of the invention comprises the faucet direction structure, pedal gearing structure, generator, supporting structure and direction detecting structure. As shown in FIG. 2, FIG. 3 and FIG. 7, faucet structure and direction detecting structure comprise faucet, faucet bracket, big gear wheel, small gear wheel and sensor. The pedal gearing as shown in FIG. 2, 3 and 7 comprise pedal, first-grade driver sprocket wheel and driven sprocket wheel, secondary driver pulley and driven pulley, the third-grade driver pulley and driven pulley. The intergrade drivers and the driven share the same rotational co-axis. The driver sprocket wheel and driven sprocket wheel are connected by chain. The driver pulley and driven pulley are connected by strap. Generator rotor is located on the third-grade driven pulley axis.

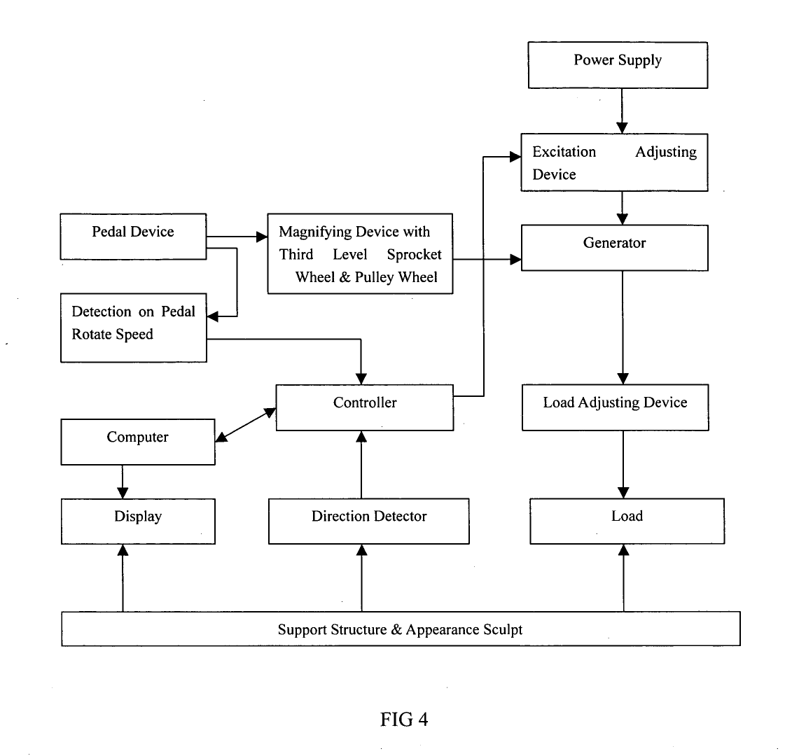

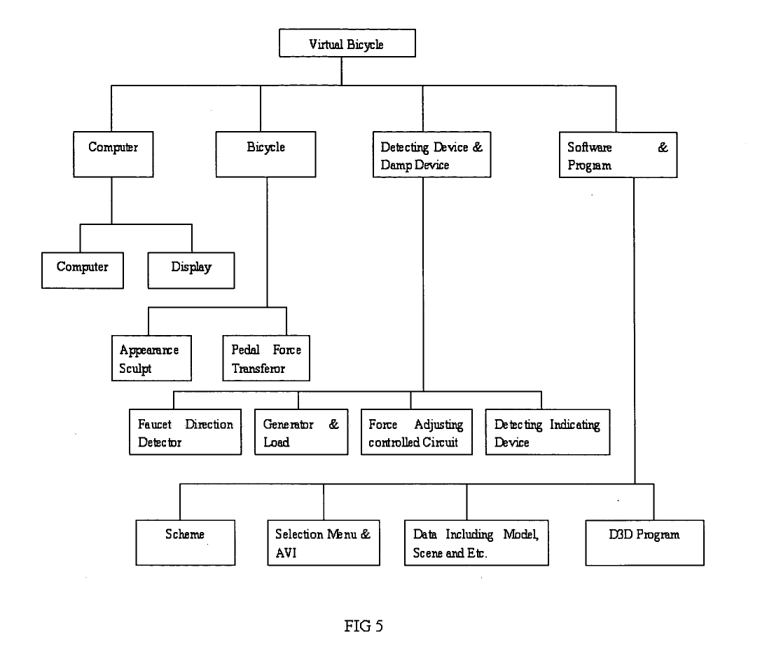

The interior control structure of the device provided in the invention as shown FIG. 4, comprises a support structure and an appearance sculpt. The display and pedal of the pedaling mechanism are exposed outside of the crust. The function of the said device and data obtained from bicycle electronic device are all under controlled of the controller communicating with computer via serial port.

Adopting virtual reality technique, the device as provided in the invention is composed of multiple parts as shown in FIG. 5, which can be divided into four parts, including computer, bicycle, testing and damp device, software and games. Each part is subdivided into small pieces, in which 3D program is used to simulate 3D vision.

Following content will provide further description on the key components: pedal device (or pedal force transferor), faucet direction detecting device, resistance adjustment control circuit and computer system.

Pedal device as shown in FIG. 2 amplifies by several times the pedaling speed, by using third-grade enlarged sprocket wheel and pulley, to meet the requirement of the rotate speed of the generator at rated output.

Faucet direction detecting device connected with faucet direction device as shown in FIG. 7, comprises the big and small gear, and the sensor on small gear.

In a preferred embodiment, a plastic potentiometer is used as the sensor, whose rotate angle usually up to one circle. Real bicycle turn around within a restricted angle, for example, it can not turn 90° or 180° on one movement. The said bicycle can simulate general motion at a rotate angle not more than 25°. The amplified two gears adopted increase the precision in testing direction.

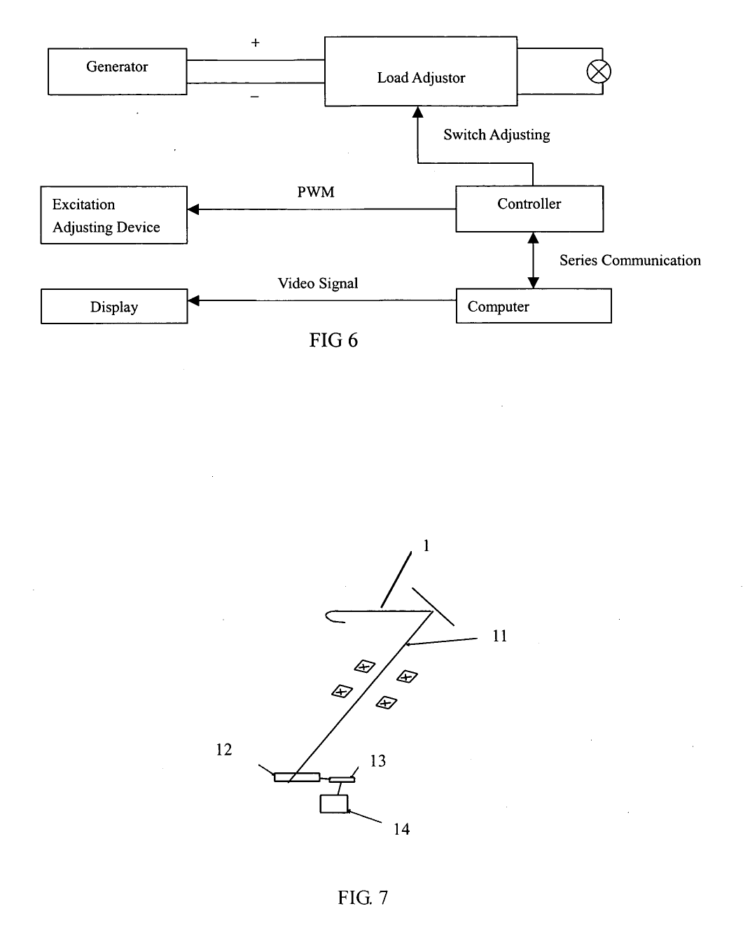

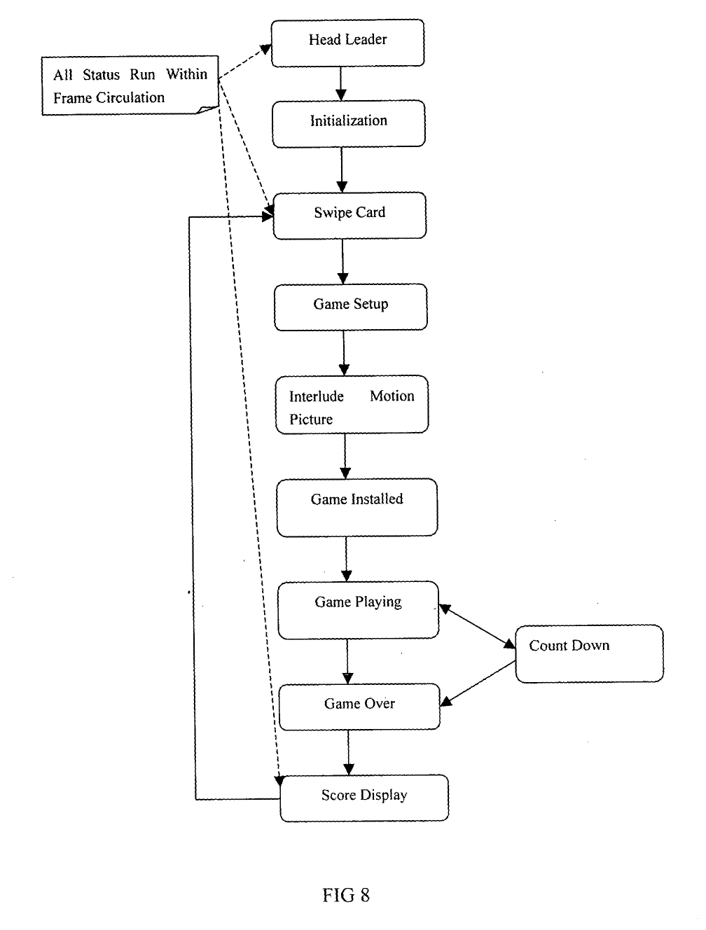

The resistance adjustment circuit as shown in FIG. 6, comprises computer, controller, excitation voltage adjustor used for adjusting interior magnetic field and load adjustor used for adjusting resistance of the load. Raising the generator excitation current or output current of generator in which way to reduce resistance value can increase the resistance born by loop. Riders can get over the resistance through pedal device.

Computer system comprises two parts as follows,

Data structure and scene data structure, including playbill, each of which corresponds to different static scene data, each static scene data corresponds to display data and disposal data. The disposal data corresponds to scenes like road surface and gradient value.

IC card reading and menu selection interface adopt the existing device and keystroke. Built-in software read the dynamic scene data.

While embodiment of the present invention has been shown and described, various modifications may be made without departing from the scope of the present invention. The invention, therefore, should not be limited, except to the following claims, and their equivalents.

What is claimed is:

1. A method of realizing virtual cycling, the method comprising:
a. Using sensor to detect bicycle speed and direction;
b. Generating electricity through pedal by driving the generator with convertible interior magnetic field;
c. Displaying the scene according to current location by the computer installed with virtual scene database;
d. Changing the current location and corresponding scenes by the setup, the detected speed and direction; and
e. Auto adjusting interior magnetic field of the said generator according to the changing scenes, thus to alter the cycling resistance produced hereby.

2. A virtual cycling method according to claim 1, wherein the scene database include many corresponding data of different cycling game, resistance parameter correspondent with the afore said scenes, wherein the resistance parameter may comprise the cycle-way gradient value of the current scene.

3. A method according to claim 1 further comprising the steps of:
a. Using the speed detecting method to calculate current speed of the simulated bicycle;
b. Obtaining the resistance parameter from the said database, then calculating current resistance based on the speed and resistance parameter; and
c. Adjusting interior magnetic field and load of the generator by resistance parameter obtained from scene database.

4. A method according to claim 1 further comprising magnifying the pedaling speed on multilevel to the extent that meets the rotate speed requirement of generator's rating output with the sprocket wheel and pulley wheels.

5. A method according to claim 1 further comprising magnifying the rotate angle of the faucet on multilevel to improve the test precision.

6. A method according to claim 1 further comprising sound output simulating the background sound of changing scene. The sensor may comprise direction sensor on detecting the bicycle faucet rotate direction and speed sensor detecting bicycle wheels rotate speed.

7. A virtual cycling apparatus comprising bicycle model, direction detector fixed on faucet devices, the speed detector and damp force device that fixed on pedal devices, computer system and display system connected with the above three devices which is applied in data conducting, virtual scene output and the corresponding resistance adjusting signal output. The damp device produces resistance according to resistance adjusting signal. Both the direction detecting device and speed detecting device have their own sensors. The damp device includes generator with an interior convertible magnetic field.

8. A virtual cycling apparatus as defined in claim 7 wherein the direction detector includes two gear wheels (one big and one small) and a sensor linked with the small one; the big wheel connecting with the faucet bracket is positioned under the bracket.

9. A virtual cycling apparatus as defined in claim 7 wherein the pedaling device comprises pedal, driver on axis, driven wheel on rotate co-axis and secondary driver, secondary driven wheel on rotate co-axis and third-rate driver, the third-grade driven and chain or pulley between driver and driven at different grade. The sensor on speed detector can be fixed on each wheel of driver and driven wheel at different grade.

10 A virtual cycling apparatus as defined in claim 7 wherein the damp device comprises damp controller connecting with computer system, excitation voltage adjustor connecting with the output end of the controller, generator connecting with the output end of the adjustor, and load adjustor whose loop and input end are connected with the said controller, and the output end is connected with the adjustable load. The loop includes load forming electrical loop between generator and the output voltage test circuit connecting with computer system. The generator rotor is on the axis of the third-rate driven wheel. The load is adjustable.
